(19) United States
(12) Patent Application Publication
(10) Pub. No.: US 2005/0116477 A1
(43) Pub. Date: Jun. 2, 2005

(54) Automatic power generation light-image fan device

(76) Inventor: Yi Feng Fang, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/994,352

(22) Filed: Nov. 23, 2004

(30) Foreign Application Priority Data
Nov. 27, 2003 (TW) 92221006

(51) Int. Cl. H02P 9/04; F03D 9/00; F01D 1/02; F03B 1/04

(52) U.S. Cl. 290/44

(57) ABSTRACT

An automatic power-generation light-image fan device is described. It has a fan motor, a vane set, a circuit board, a programmable chip, an automatic power-generation component and a rectifier filter circuit. In this device, the circuit board is mounted on the vanes of the vane set and also has plural light-emitting elements, which are respectively connected to I/O terminals of the programmable chip, and an accommodating room is mounted on an inner surface of the vane set, in which an inner circular surface of the accommodating room is circularly mounted by an inductance coil whose ends are connected to an input terminal of the rectifier filter circuit. Thereby, the light-emitting elements mounted on the fan can be controlled to generate various different twinkling light-image variations and an effect of persistence of vision. Besides, between the light-emitting elements, it also can have an effect of light-mixing for generating different color variations.

### BACKGROUND OF THE INVENTION

1. Field of the Invention

The present invention is related to an automatic power generation light-image fan device, and more particularly to a fan device that can control light-emitting elements of the vanes to produce various twinkling light-images, also having an effect of persistence of vision and different light-mixing colors.

2. Description of Related Art

Generally, a common fan does not have a light-emitting decoration or a warning function, and a fan with a light-emitting function is always a heat-dispersing fan, such as, for example, TW patent No. 520149. In this disclosure, several plugging holes are formed in a circular portion of a fan base in an isogonal manner, and light-emitting diodes are correspondingly located in these plugging holes, respectively. Furthermore, these light-emitting diodes are connected to one another in series through printed conducting lines, and the printed conducting lines are also connected in series with the conducting lines of a vane set, so that when the components of the vanes are electrically conducted, the vanes rotate to provide air convection, and simultaneously, because the rotation of the vanes conducts the light-emitting diodes to illuminate and also refracts the light emitted therefrom, the heating-dispersing fan radiates light and has a novel luminous effect.

However, the above-mentioned light-emitting and luminous effects still cannot provide a light-image or color-mixing effects for generating better visual effects. Moreover, the heating-dispersing fan does not have a function of automatic power generation.

### SUMMARY OF THE INVENTION

The object of the present invention is to provide a mechanism for making a common fan have an automatic power generation function, and simultaneously, through specific circuit designs, to control the light-emitting elements mounted thereon for producing various twinkling light-image variations so that an effect of persistence of vision and different mixing-colors can be achieved.

For achieving the object described above, the applicant proposes an automatic power generation light-image fan device with a novel structure and circuit design, including the following elements. A fan motor has a base and a mandrel mounted on said base. A vane is set having a housing base, an axle hole in said housing base for passing therethrough said mandrel of said fan motor, an accommodating room mounted on an inner surface of said housing base passed through by said mandrel, and plural vanes circularly mounted around said housing base. An automatic power generation component has one or more permanent magnets and is mounted on an inner surface of said fan motor, with an inductance coil circularly mounted inside said accommodating room of said vane set at a position corresponding to said permanent magnet. A rectifier filter circuit is connected to ends of the inductance coil of said automatic power generation component for rectifying and filtering an AC voltage generated by said automatic power generation component so as to obtain a DC voltage. A circuit board is mounted on said vanes of said vane set and has more than one light-emitting element. A programmable chip is mounted on said circuit board and is respectively connected with said rectifier filter circuit and said light-emitting elements, and has a power terminal, a trigger terminal and plural I/O terminals. The power terminal is connected to an output terminal of the rectifier filter circuit and each I/O terminal is respectively connected to a light-emitting element. When the programmable chip outputs a DC voltage at the rectifier filter circuit, each light-emitting element is accordingly triggered to depend on a control of different timings of a waveform output by said programmable chip and also on different twinkling timings and orders for generating various twinkling light-image variations, as well as an effect of persistence of vision. Between said light-emitting elements, an effect of light-mixing for generating different color variations is also formed.

The above-mentioned programmable chip is a single chip having an oscillator, a frequency selector, a ROM, a counter, a pattern memory and a buffer integrated thereon.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows an appearance drawing of the present invention;

FIG. 2 shows a decomposition drawing of the present invention;

FIG. 3 shows a circuit block of the present invention;

FIG. 4 shows a circuit block of a programmable chip according to the present invention;

FIG. 5A shows a timing drawing of different frequencies output by the programmable chip to light-emitting elements according to the present invention;

FIG. 5B is a schematic view showing the variation of persistence of vision produced from the timing shown in FIG. 7A when the device of the present invention moves;

FIG. 6A is another timing drawing of different frequencies output by the programmable chip to light-emitting elements according to the present invention;

FIG. 6B is a schematic view showing the variation of persistence of vision produced from the timing shown in FIG. 8A when the device of the present invention moves;

FIG. 7A is another further timing drawing of different frequencies output by the programmable chip to light-emitting elements according to the present invention;

FIG. 7B is a schematic view showing the variation of persistence of vision produced from the timing shown in FIG. 9A when the device of the present invention moves;

FIG. 8 is a decomposition drawing of a second embodiment according to the present invention;

FIG. 9 is an appearance drawing of a third embodiment according to the present invention;

FIG. 10 is an appearance drawing of a fourth embodiment according to the present invention; and

FIG. 11 is a performing block showing the rectifier filter circuit being connected to another set of circuit.

### DETAILED DESCRIPTION OF PREFERRED EMBODIMENTS

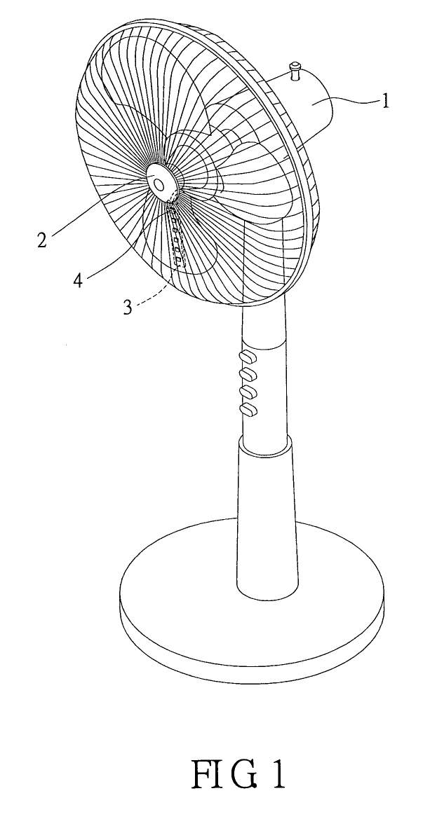

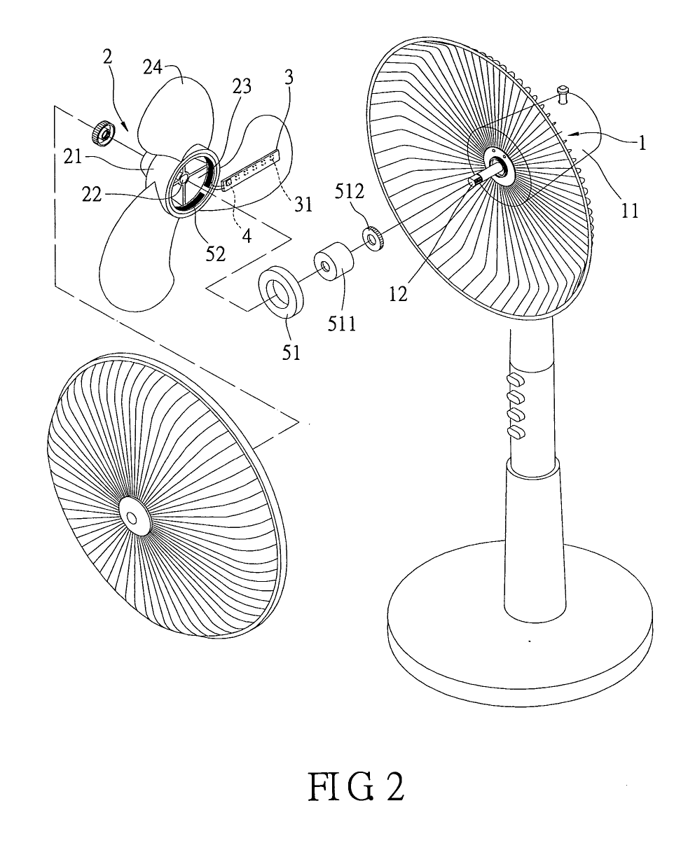

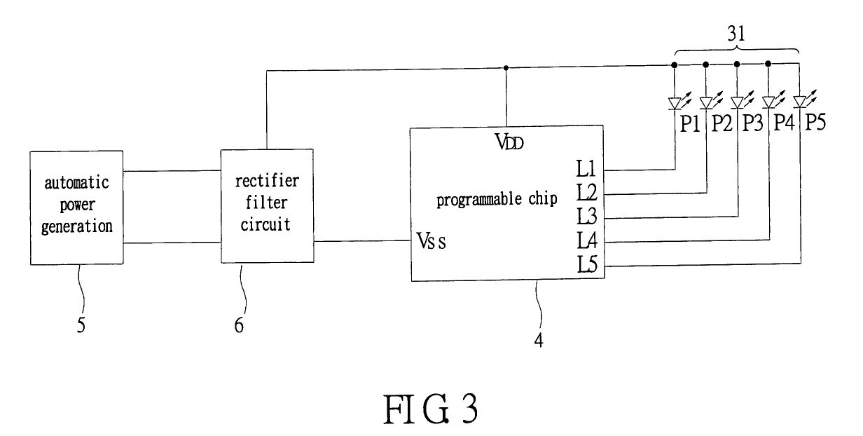

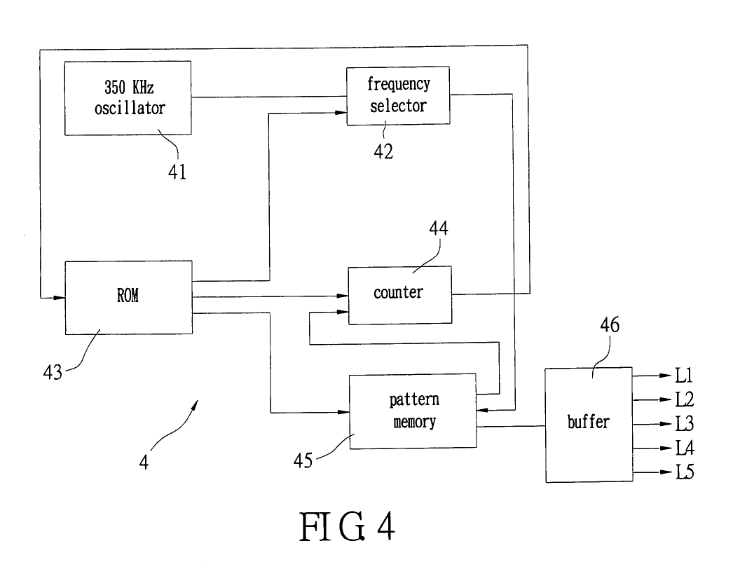

Reference is made to FIGS. 1 to 4. An automatic power generation light-image fan device of the present invention includes a fan motor 1, a vane set 2, a circuit board 3, a programmable chip 4, an automatic power generation component 5 and a rectifier filter circuit 6. The fan motor 1 is formed by employing a base 11 with a shaft sleeve for sleeving on a mandrel 12 of silicon steel plates and a rotor and then combining through a bolt set. Because the actions between all these components are well-known in the prior arts, they will not be further discussed here.

The vane set 2 has an integrally formed housing base (rim) 21 mounted therein in an approximate circular form, and a central portion of the housing base 21 further has an axle hole 22 mounted thereon for passing therethrough the mandrel 12 of the fan motor 1. Moreover, an accommodating room 23 is formed on an inner surface of the housing base 21 passed through by the mandrel 12, and plural vanes 24 are circularly mounted around the housing base 21.

The circuit board 3 is mounted on the vanes 24 of the vane set 2 and has arranged thereon a plurality of light-emitting elements 31. In a preferred embodiment according to the present invention, there are five light-emitting elements P1-P5 with different colors, each of which is a LED.

The programmable chip 4 is mounted in the circuit board 3 and is a single chip having a 350 KHz oscillator 41, a frequency selector 42, a ROM 43, a counter 44, a pattern memory 45 and a buffer 46 integrated thereon. Furthermore, the programmable chip 4 also includes a power terminals VDD, VSS and plural I/O terminals L1-L5. Each I/O terminal is respectively connected to a light-emitting element 31. Therefore, when each light-emitting element 31 is driven by the programmable chip 4, it will depend on a control of different timings of the waveform output by the programmable chip 4 and also on different twinkling timings and orders for generating various twinkling light-image variations, as well as an effect of persistence of vision.

The rectifier filter circuit 6 is connected to the power terminals VDD, VSS of the programmable chip 4 and is composed of a bridge rectifier and a filter capacitance. The rectifier filter circuit 6 can rectify and filter an input AC voltage to obtain a DC voltage for supplying to the programmable chip 4.

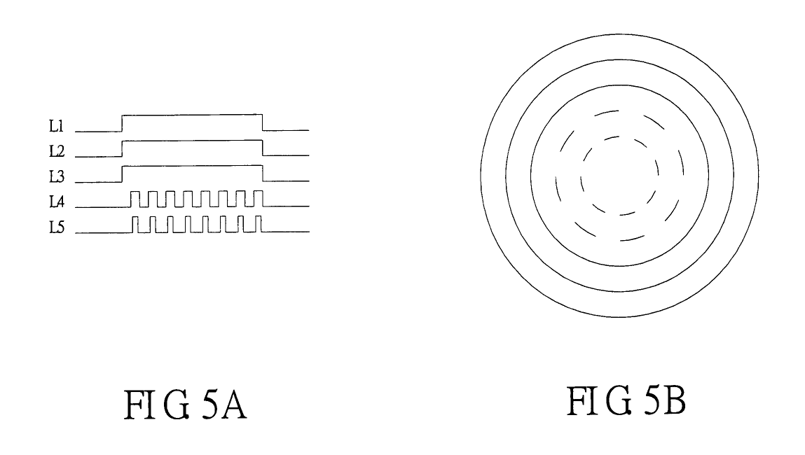

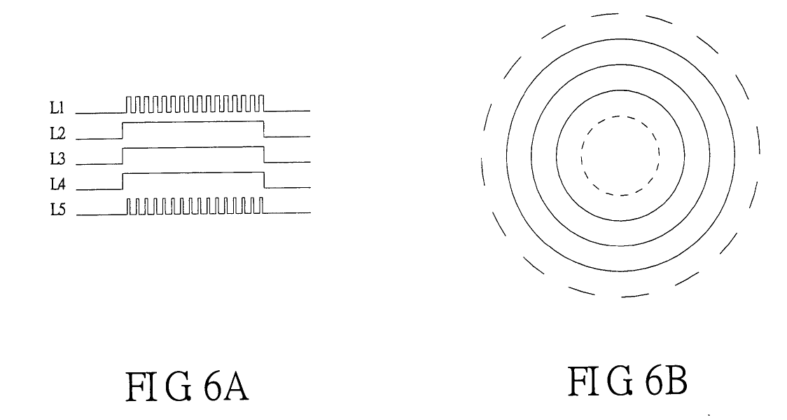

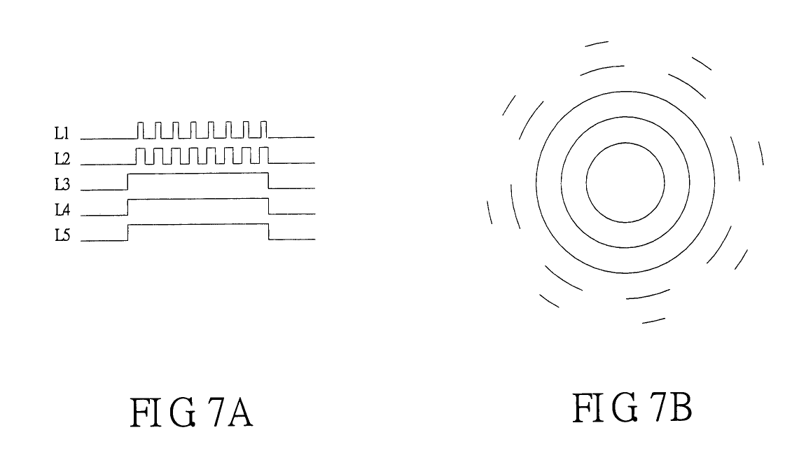

The automatic power generation component 5 has one or more permanent magnets 51. In a preferred embodiment according to the present invention, a ring permanent magnet 51 is assembled on a turncap 5 through a connecting piece 511. The permanent magnet 51 has an inductance coil 52 thereon circularly mounted inside the accommodating room 23 of the vane set 2 at a position corresponding to the permanent magnet 51, and two ends of a continuous conducting line of the inductance coil 52 are connected to an input terminal of the rectifier filter circuit 6 so as to generate an electromotive force through a rotation of the mandrel 12 of the fan motor 1 for supplying to the rectifier filter circuit 6 and obtaining a DC voltage. Moreover, when the programmable chip 4 is functioned, the light-emitting element 31 is triggered so that it depends on a control of different timings of the waveform output by the programmable chip 4, as shown in FIG. 5A, FIG. 6A and FIG. 7A, and also on different twinkling timings and orders for generating various twinkling light-image variations, as well as an effect of persistence of vision, as shown in FIG. 5B, FIG. 6B and FIG. 7B. In addition, between the light-emitting elements 31, it also has an effect of light-mixing for generating different color variations.

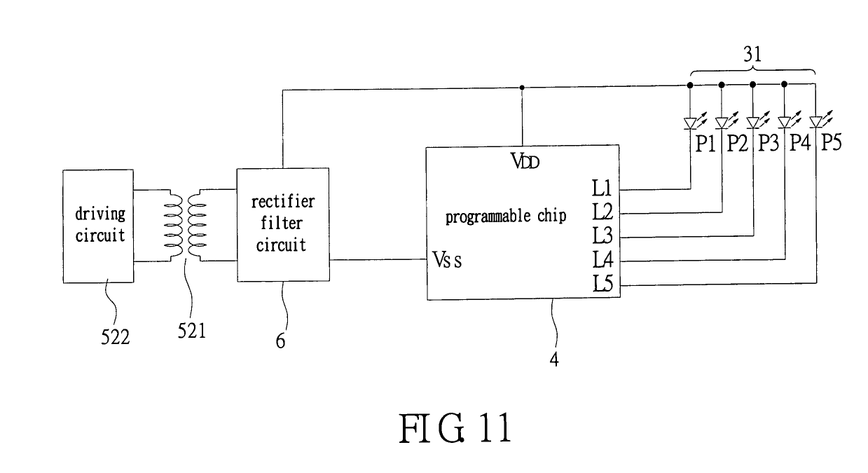

Reference is made to FIG. 11. An input terminal of the rectifier filter circuit 6 is connected to a coupling coil 521 having an input terminal connected to a driving circuit 522, which converts a DC voltage into an AC voltage. Accordingly, through coupling a voltage obtained from the driving circuit 522 to the rectifier filter circuit 6 by the coupling coil 521, the rectifier filter circuit 6 can rectify and filter the input voltage for obtaining a DC voltage. At this time, the light-emitting element 31 is triggered by the programmable chip 4 so as to depend on a control of different timings of the waveform output by the programmable chip 4 and also on different twinkling timings and orders for generating various twinkling light-image variations, as well as an effect of persistence of vision. Further reference is made to FIG. 5A, which discloses that when the first to the third LEDs P1-P3 are driven by the programmable chip 4 to have a frequency with lasting light and the fourth and the fifth LEDs P4 and P5 have different frequencies, the fan rotates to produce a pattern shown in FIG. 5B.

Further reference is made to FIG. 6A, which discloses that when the second to the fourth LEDs P2-P4 are driven by the programmable chip 4 to have a frequency with lasting light and the first and the fifth LEDs P1 and P5 to have different frequencies, the fan rotates to produce a pattern shown in FIG. 6B.

Further reference is made to FIG. 7A, which discloses that when the third to the fifth LEDs P3-P5 are driven by the programmable chip 4 to have a frequency with lasting light and the first and the second LEDs P1 and P2 to have different frequencies, the fan rotates to produce a pattern shown in FIG. 7B.

Furthermore, the above-mentioned automatic power generation component 5 and the rectifier filter circuit 6 also can be mounted on a suitable portion of the fan motor 1 so that the programmable chip 4 can make the automatic power generation component 5 generate an induced voltage, which is then rectified and filtered by the rectifier filter circuit 6 for obtaining a DC voltage. At this time, the programmable chip 4 triggers the light-emitting element 31 so that the light-emitting element 31 can depend on a control of different timings of the waveform output by the programmable chip 4 and also on different twinkling timings and orders for generating various twinkling light-image variations, as well as an effect of persistence of vision. In addition, between the light-emitting elements 31, it also has an effect of light-mixing for generating different color variations.

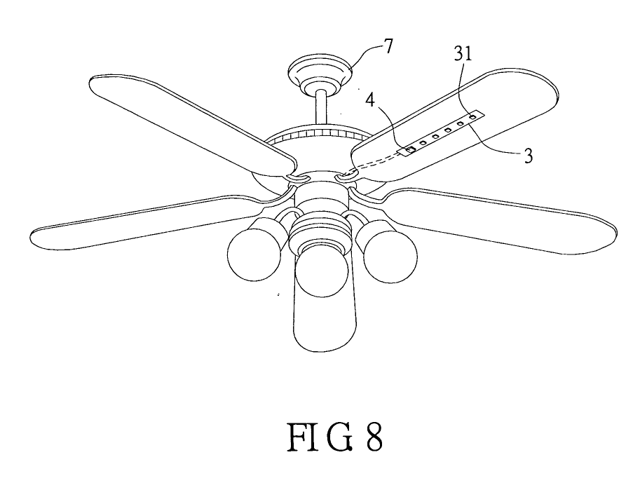

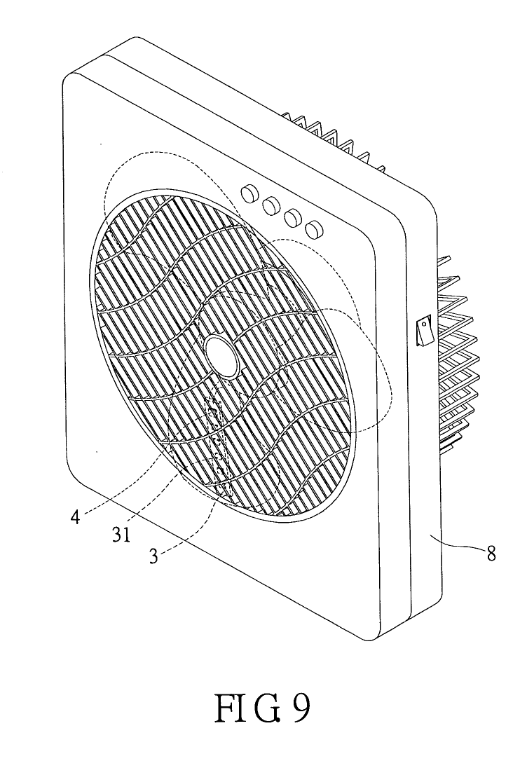

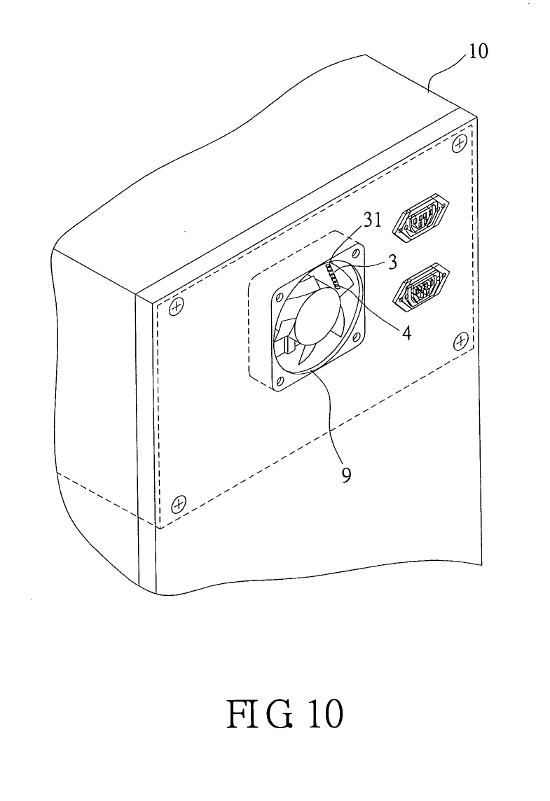

Besides, the circuit board 3, the light-emitting elements 31, the rectifier filter circuit 6, the programmable chip 4 and the automatic power generation component 5 according to the present invention are also suitable for application to a ceiling fan 7, a standing fan 8, or a transparent computer case 10 with a heat dispersing fan 9, as shown in FIG. 8, FIG. 9 and FIG. 10, respectively.

As can be seen from the above, through the novel structure and circuit design of the present invention, the light-emitting elements mounted on the fan can be controlled to generate various twinkling light-image variations and also an effect of persistence of vision. Moreover, between the light-emitting elements, it also can have an effect of light-mixing for generating different color variations which is totally different from the prior art.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An automatic power-generating light-image fan device, comprising:
a fan motor having a base and a mandrel mounted on said base;
a vane set having a housing base, an axle hole being mounted on said housing base for passing therethrough said mandrel of said fan motor, and plural vanes circularly mounted around said housing base;
an automatic power generation component mounted on said fan motor;
a rectifier filter circuit connected to said automatic power generation component for rectifying and filtering an AC voltage generated by said automatic power generation component so as to obtain a DC voltage;
a circuit board mounted on said vanes of said vane set and having more than one light-emitting element; and
a programmable chip mounted on said circuit board and respectively connected with said rectifier filter circuit and said light-emitting elements, wherein when said programmable chip receives said DC voltage output by said rectifier filter circuit, said light-emitting element is accordingly triggered to depend on a control of different timings of a waveform output by said programmable chip for generating various twinkling light-image variations and also an effect of persistence of vision, and wherein between said light-emitting elements, an effect of light-mixing for generating different color variations is also formed.

2. The device according to claim 1, wherein said programmable chip is a single chip having an oscillator, a frequency selector, a ROM, a counter, a pattern memory and a buffer integrated thereon.

3. The device according to claim 2, wherein said programmable chip comprises a power terminal, a trigger terminal and plural I/O terminals, said power terminal being connected to an output terminal of said rectifier filter circuit and said plural I/O terminals being respectively connected to a light-emitting element.

4. The device according to claim 1, wherein an input terminal of said rectifier filter circuit is connected to a coupling coil having an input terminal connected to a driving circuit which converts a DC voltage into an AC voltage, and wherein through coupling a voltage obtained from said driving circuit to said rectifier filter circuit by said coupling coil, said rectifier filter circuit is capable of rectifying and filtering said input voltage for obtaining a DC voltage.

5. An automatic power generation light-image fan device, comprising:
a fan motor having a base and a mandrel mounted on said base;
a vane set having a housing base, an axle hole mounted on said housing base for passing therethrough said mandrel of said fan motor, an accommodating room mounted at an inner surface of said housing base passed through by said mandrel, and plural vanes circularly mounted around said housing base;
a circuit board mounted on said vanes of said vane set and having plural light-emitting elements;
a programmable chip mounted on said circuit board and connected to said light-emitting elements respectively, and having a power terminal and plural I/O terminals, said plural I/O terminals being connected to a light-emitting element, respectively;
a rectifier filter circuit connected to said power terminal of said programmable chip for rectifying and filtering an input AC voltage so as to obtain a DC voltage for supplying to said programmable chip; and
an automatic power generation component having one or more permanent magnets and mounted on an inner surface of said fan motor, wherein an inductance coil is circularly mounted inside said accommodating room of said vane set at a position corresponding to said permanent magnet and two ends of said inductance coil are connected to an output terminal of said rectifier filter circuit so that an electromotive force is generated through a rotation of said vanes and is supplied to said rectifier filter circuit, and wherein when said programmable chip functions, said light-emitting element is triggered to depend on a control of different timings of a waveform output by said programmable chip for generating various twinkling light-image variations and also an effect of persistence of vision, between said light-emitting elements, an effect of light-mixing for generating different color variations also being formed.
